(19) United States
(12) Patent Application Publication
(10) Pub. No.: US 2016/0024612 A1
(43) Pub. Date: Jan. 28, 2016

(54) Method And Device For Obtaining Pure, Additive-Free Scrap Iron From A Mixture Of Comminuted Scrap Metal

(71) Applicant: Alexander Koslow, Landshut (DE)

(72) Inventor: Alexander Koslow, Landshut (DE)

(21) Appl. No.: 14/875,301

(22) Filed: Oct. 5, 2015

Related U.S. Application Data
(63) Continuation of application No. PCT/DE2013/000183, filed on Apr. 10, 2013.

(51) Int. Cl. C22B 7/00; B02C 23/12; B07B 1/42; B03C 1/30; B07B 1/40; C22B 1/00; B02C 23/14

(52) U.S. Cl. CPC C22B 7/005; C22B 1/005; B02C 23/12; B02C 23/14; B03C 1/30; B07B 1/40; B07B 1/42

(57) ABSTRACT

A method and a device for obtaining scrap iron from a mixture of comminuted scrap metal. The device and the method are characterized in that individual steps are carried out in order to remove iron from additives adhering to the iron. Emphasis is placed on copper and copper-containing additives. Comminuted scrap metal is divided into small and large scrap parts using a sieve device. The small scrap parts are transported to a scrap sorting machine, and the large material parts are returned to the macerator. In the scrap sorting machine, copper-containing material is sorted out, and iron which still contains copper is guided to a special over-belt magnet via a vibrating trough, the over-belt magnet shaking and rocking the copper-containing material over the belt section such that nonmagnetic additives drop down from the iron, and iron with a copper content of only 0.01% to a maximum of 0.1% is obtained.

### FIELD OF THE INVENTION

The present invention relates to the steel processing industry. In particular, the present invention relates to systems and methods for obtaining pure ferrous scrap from shredded scrap metal.

### BACKGROUND OF THE INVENTION

The steel processing industry, in particular the automotive industry, demands ever higher standards in the quality of the ferrous scrap recovered from scrap metal. This ferrous scrap may only contain admixtures of non-ferrous metals that contain less than 0.01% to a maximum of 0.1%. Special attention is given to the copper content as an admixture.

Equipment and processes that deal with this problem are already known (US Patent specification 2009/0236268 A1 and US Patent specification 2010/0017020 A1). The processes and equipment in these patent specifications also aim to produce pure ferrous scrap from scrap metal, the copper content of which is below the threshold values of 0.03% to 0.2%. However, the measures proposed are not sufficient to achieve these values. For this reason, they merely remain a desired objective. Controls are also implemented after each process step that serve, however, to determine the deviation from the desired objective, whereby the variations in the devices at the control measurement points appear less significant.

### SUMMARY OF THE INVENTION

The invention has now assumed the task of developing a process and equipment that can extract pure ferrous scrap from shredded scrap metal. The undesired substances in the pure materials obtained in this process, e. g. the copper admixtures in the pure ferrous scrap, are actually below 0.01% to max. 0.1%. Compliance with these limits (0.01% to max. 0.1%) of admixtures in the ferrous scrap must be strictly observed. If these limits are exceeded at the control measurement points, then the relevant separation runs can be repeated until the required purity is achieved.

In the procedure according to the invention, shredded scrap metal is sorted in order to separate the iron and admixtures, particularly copper. Shredded scrap is transported to the sieve via a feed conveyor belt. The sieve separates the large and small metal parts. Loading equipment places the metal parts onto sensor-controlled scrap sorting equipment. Material containing copper is removed in the scrap sorting equipment to obtain, on the one hand, iron free of copper admixtures. On the other, no scrap sorting equipment is technically able to eliminate 100% of the parts containing copper. Any material that has not been eliminated still does not have the required degree of purity of 0.01% to a maximum of 0.1% copper content. This material is, therefore, conveyed to an overbelt magnet that has a very specific construction. The material that is conveyed to the overbelt magnet will be moved through with a constant, intense vibration and shaking movement. This will remove all the amagnetic admixtures that still adhere to the iron, so that that magnetized iron is left at the end of the overbelt magnet that corresponds to the required purity level of 0.01% to max. 0.1% copper content. The overbelt magnet is designed for this purpose in such a manner that a continuous series of magnets is arranged in the space between the upper and lower run of an amagnetic conveyor belt near the lower run in such a manner that their magnetic poles that are in proximity each have the same polarity. This means that the south magnetic pole of the first magnet faces the south pole of the next magnet. The north pole of this magnet interacts with the north pole of the magnet immediately after it, and so on. The smallest number in the magnet sequence will be two magnets with this pole configuration. The material conveyed, the polarity and polarity distance between the magnets is crucial to achieve the intense vibrating and shaking movement along the entire belt section of the overbelt magnet. The south pole to south pole and north pole to north pole polarity, and the maintaining of a minimum distance that should be toward 0 and the poles facing each other, are crucial for the required vibrating and shaking movement to remove the admixtures from the ferrous material.

In parallel to the process steps described above, the separating process is divided subsequent to passing through the scrap sorting machine. Scrap material that still contains composite materials that bind the iron and copper, e.g. characterized by any interlocking or other mechanical connection between the two materials, are separated manually in a parallel process line. After this separation from the composites containing copper, the copper-ferrous material obtained in this manner is again conveyed to an overbelt magnet in the same configuration as described above, and it is separated from the undesired admixtures by a process of a constant, intense vibration and shaking movement over the entire belt section of the overbelt magnet. The iron obtained in this manner corresponds to the required specifications of 0.01% to a maximum 0.1% copper admixtures.

A control is provided at the end of each overbelt magnet conveyer belt section that is responsible for compliance with the targeted admixtures of copper in the iron.

The material with the iron removed (e. g. total copper content) is also sent for appropriate further processing.

The now pure iron is sent for smelting to be turned into high-quality steel.

### BRIEF DESCRIPTION OF THE DRAWINGS

FIG. 1 illustrates a method for eliminating admixtures from shredded scrap metal to produce pure ferrous scrap in accordance with an embodiment of the present invention.

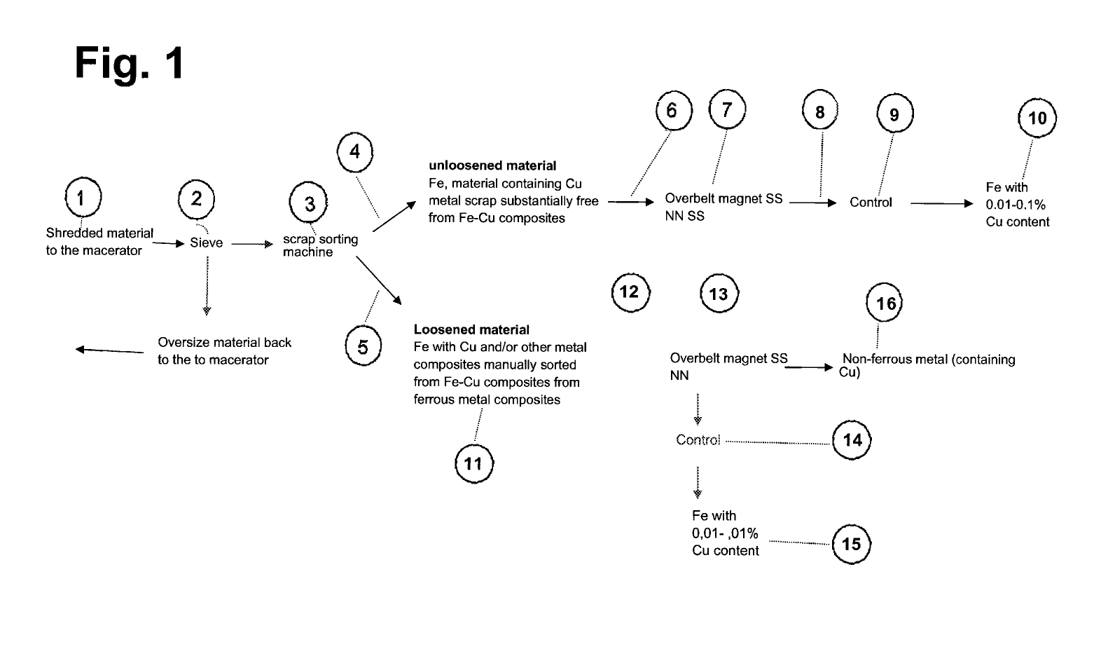

FIG. 2 illustrates an overbelt magnet of the system for eliminating admixtures from shredded scrap metal to produce pure ferrous scrap in accordance with the present invention.

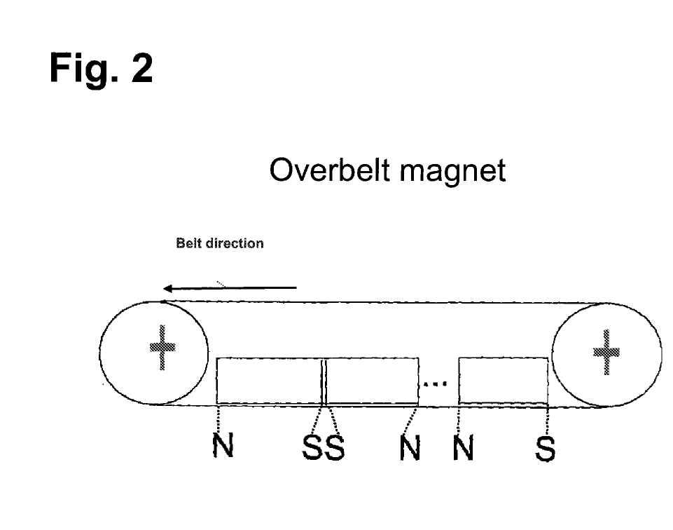

### DETAILED DESCRIPTION OF THE INVENTION

The material delivered from a macerator (1) (e. g. shredder, hammer mill or other device) will be conveyed to the sieve (2) where large and small material parts will be separated in order to prevent oversize metal parts from entering the scrap sorting machine. The sieved material will be delivered to the scrap sorting machine (3) via a conveyance device. The large scrap material retained in the sieve, the “oversize” material, will be returned to the macerator for further shredding. In the scrap sorting machine (3), any material that has not been eliminated (containing Fe, Cu, scrap essentially free from Fe-Cu composites) will be conveyed via a transport device (6) to an overbelt magnet (7) that comprises at least 2 magnets aligned in series in the conveying direction, and whose pole faces are directly connected, whereby the south magnetic pole of a first magnet will face the south pole of the magnet following it, and the north pole of this magnet will face the north pole of the magnet immediately following it, and so on. This configuration of magnets and their poles will hold the scrap metal on the amagnetic conveyor belt of the overbelt magnet, which is subject to a constant, intensive vibration and shaking movement. This vibration and shaking movement will shake all the non-magnetic components from the scrap in order to obtain pure ferrous scrap (10) (0.01 to max. 0.1% admixtures of Cu) at the end the overbelt magnet. A final visual inspection (9) is to confirm this. Once the loose material has passed through the scrap sorting machine (3) (Fe, Cu and/or composite materials), it is sorted manually, during which the Fe—Cu composites and other ferrous metal composites (anchors, electrical conductor composites, etc.) are removed. The remaining ferrous material containing copper is again placed on a transport device (12) and passed under an overbelt magnet (13). This overbelt magnet (13) is designed in the same manner as the overbelt magnet described above (7), so that the material containing copper is again subject to an intense vibration and shaking movement as it passes along the belt. All the non-magnetic components in the material are again shaken off to produce pure iron (0.01% to max. 0.1% Cu) at the end of the overbelt magnet (13). A visual inspection is carried out at the end of the entire process, in order to ensure that the Cu has been eliminated from the ferrous scrap. The non-ferrous material that has been removed will be subject to further appropriate processing.

The following is a description of various components of the system and method as illustrated in the Figures:

1 Shredded scrap material from macerator (e.g. shredder, hammer mill, etc.)

2 Sieve

3 Scrap sorting machine

4 Unloosened material (material containing Fe, Cu essentially free from Fe—Cu composites)

5 Loosened material (Fe with Cu and/or other material formed of composites)

6 Transport device to 1. Overbelt magnet (vibrating channel)

7 1. Overbelt magnet

8 Transport device to the control station

9 Visual inspection for any physically present Cu and other non-ferrous metals

10 Ferrous scrap with 0.01% to max. 0.1% Cu content

11 Manual sorting of Fe—Cu composites and other Fe non-ferrous metal composites

12 Transport device to 2. overbelt magnet

13 2. Overbelt magnet

14 Visual inspection for any Cu and other non-ferrous metals still present

15 Fe scrap with 0.01-max. 0.1% Cu

16 non-ferrous metals (also Cu)

What is claimed is:

1. A method for eliminating admixtures from a batch of scrap metal to produce pure ferrous scrap, comprising the steps of:
shredding scrap metal with a macerator;
sorting oversized components using a sieve;
feeding the sieved material to a scrap sorting machine having detection sensors, and removing materials containing copper and composite material;
feeding the remaining scrap metal to an overbelt magnet having an amagnetic conveyor belt with an upper run and a lower run and at least one pair of magnets positioned adjacent the lower run and having aligned north to north and south to south poles, and vibrating the scrap metal material placed on the belt over the entire conveying section; and
visually inspecting the remaining ferrous scrap for any copper physically attached to the scrap.

2. The method in accordance with claim 1, further comprising the step of returning the separated oversized material to the macerator after the sorting step.

3. The method in accordance with claim 1, further comprising the steps of:
processing any loose materials in the scrap sorting machine, said loose materials comprising ferrous metals with copper and/or other non-ferrous metals in the composite material, by manually sorting the iron-copper composites and other iron non-ferrous composites;
feeding the remaining loose material to an additional overbelt magnet having an amagnetic conveyor belt with an upper run and a lower run and at least one pair of magnets positioned adjacent the lower run and having aligned north to north and south to south poles, and vibrating the material placed on the belt over the entire conveying section;
visually inspecting the resulting pure ferrous scrap for any copper still physically attached to the material; and
collecting eliminated non-ferrous metals for further processing.

4. An apparatus for removing admixtures from a batch of scrap metal, comprising
a feed for supplying shredded scrap metal to a sieve, said sieve coupled to a scrap sorting machine on one side and to a macerator on the other side;
wherein the scrap sorting machine is sensor controlled and comprises a vibration channel that creates a vibration movement in copper containing material placed in the channel, said channel comprising an amagnetic conveyor belt with an upper run and a lower run and at least one pair of magnets positioned adjacent the lower run, wherein the polarity of the magnets is aligned so that a north pole of a first magnet is facing a conveying direction of the belt and facing a north pole of a second magnet, and a south pole of the second magnet is facing a south pole of a next magnet; and
a control station positioned after the overbelt magnet.

5. The apparatus in accordance with claim 4, further comprising a feed for supplying the discarded material from the scrap sorting machine to a sorting station for manual separation of iron-copper composites and iron/non-ferrous composites; a feed for transporting iron with copper loosely attached from the sorting station to an additional overbelt magnet comprising a vibration channel that creates a vibration movement in copper containing material placed in the channel, said channel comprising an amagnetic conveyor belt with an upper run and a lower run and at least one pair of magnets positioned adjacent the lower run, wherein polarity of the magnets is aligned so that a north pole of a first magnet is facing a conveying direction of the belt and facing a north pole of a second magnet, and a south pole of the second magnet is facing a south pole of a next magnet;
a control station coupled to the additional overbelt magnet; and
an outlet for collecting non-ferrous metals for further processing.
